(19) United States
(12) Patent Application Publication
(10) Pub. No.: US 2011/0316664 A1
(43) Pub. Date: Dec. 29, 2011

(54) REMOTE CONTROL FOR SOUND SYSTEM

(76) Inventors: Andrew Olcott, Newtonville, MA (US); Lee Zamir, Cambridge, MA (US); Darius Mobed, Watertown, MA (US); Neil Gelfond, Shrewsbury, MA (US)

(21) Appl. No.: 12/824,554

(22) Filed: Jun. 28, 2010

(51) Int. Cl. G05B 19/02

(52) U.S. Cl. 340/4.37

(57) ABSTRACT

A remote control for a sound system includes a first type of wireless system for transmitting commands for controlling operation of a sound output device. The remote control also includes a second type of wireless system for wirelessly transmitting signals that represent sounds created by a first human voice to a first portable audio storage device which can be electrically temporarily connected to the sound output device.

### BACKGROUND

This disclosure relates to a remote control for operating a sound output device.

There are a number of sound output devices on the market today to which a portable multimedia storage device (e.g. an iPhone®) can be mechanically and electrically connected. An example of such a sound output device is a SoundDock® II digital music system (DMS) sold by Bose Corp. When an iPhone® is inserted into a dock in the DMS, audio files (e.g. music) stored in the iPhone can be transmitted to and played out loud by the DMS. A user of the DMS would typically use an associated remote control to control playing of the audio files. As such, the user is often located at a distance from the DMS. When the iPhone® receives a phone call or the user wants to make a phone call, the user will need to first walk over to the DMS and then remove the iPhone from the DMS. At the conclusion of the call, the user would need to reinsert the iPhone® into the DMS to continue listening to audio file via the DMS. Having to take all of these steps to take or make a phone call is inconvenient to say the least. These issues can be present in other types of DMSs besides the SoundDock® II and with other types of portable multimedia storage device besides the iPhone®.

The iPhone® also has voice recognition capabilities. As such, a person can say a command for controlling audio play back such as “next track”, and the iPhone will react by starting to play a next track in a current sequence of audio files. As the person gets further away from the iPhone®, the ability of the voice recognition system to operate correctly decreases. Having to remain relatively close to the iPhone® in order to use the voice recognition system is problematic.

Remote controls usually have replaceable batteries. When the batteries run low on electrical power, they must be replaced. If the user of the remote control does not have the correct size spare batteries on hand, the remote control will not be able to be used to operate its associated device. It would be nice to have a remote control with a rechargeable battery which can conveniently be recharged.

The DMS mentioned above cannot wirelessly receive audio files for playback. Portable multimedia storage devices are entering the market with the ability to wirelessly transmit audio files. It would be nice if non-wireless DMSs could be conveniently retrofitted so that they could wirelessly receive audio files for playback.

### SUMMARY

In one aspect, a remote control for a sound system includes a first type of wireless system for transmitting commands for controlling operation of a sound output device. The remote control also includes a second type of wireless system for wirelessly transmitting signals that represent sounds created by a first human voice to a first portable audio storage device which can be electrically temporarily connected to the sound output device.

Embodiments may include one or more of the following features. The first type of wireless system operates in the infrared band. The second type of wireless system operates in the radio frequency band. The first portable audio storage device includes a voice user interface feature that reacts to the signals by controlling output of audio signals stored on the first portable audio storage device for reproduction by the sound output device. The remote control may further include a rechargeable battery that can be recharged when the remote control is connected to the sound output device. The remote control may further include a microphone for capturing the first human voice and a speaker for reproducing a second human voice which has been wirelessly received by the remote control from the first portable audio storage device (the first portable audio storage device having wirelessly received the second human voice from a remote location). When the first portable audio storage device is not electrically connected to the sound output device, the remote control may be electrically temporarily connected to the sound output device at a same location as where the first portable audio storage device connects to the sound output device. The second wireless system wirelessly may receive audio signals from the first portable audio storage device. The second wireless system may wirelessly receive audio signals from a second portable audio storage device that is different from the first portable audio storage device.

In another aspect, a sound system includes a sound output device including a speaker for producing sounds, and a remote control for transmitting wireless commands over a first wireless system for controlling operation of the sound output device. The sound system also includes a dock to which the remote control and a first portable audio storage device can be interchangeably electrically connected.

Embodiments may include one or more of the following features. The remote control includes a second wireless system capable of receiving wireless audio signals and providing said wireless audio signals to the sound system when the remote control is electrically connected to the sound system. The wireless audio signals are received by the remote control from the first portable audio storage device. The wireless audio signals are received by the remote control from a second portable audio storage device which is different from the first portable audio storage device. When the remote control is electrically connected to the dock, a rechargeable battery in the remote control is electrically charged. When the portable audio storage device is connected to the dock, the remote control can wirelessly transmit signals representing sounds created by a first human voice to the portable audio storage device. The portable multimedia storage device can wirelessly transmit audio signals representing sounds created by a second human voice to the remote control.

In yet another aspect, a method of operating a sound system includes the steps of providing a sound output device that includes a dock and temporarily electrically connecting one of a remote control device and a first portable audio storage device to the dock. Audio signals are wirelessly received at the remote control when the remote control is connected to the dock. Signals representing a first human voice from the remote control are wirelessly transmitted to the first portable audio device when the first portable audio device is connected to the dock.

Embodiments may include one or more of the following features. The remote control uses a same wireless system for receiving audio signals as is used to transmit the human voice signals to the first portable audio storage device. When the remote control is connected to the dock, the audio signals are used by the sound output device to create sound. When the first portable audio storage device is connected to the dock, the human voice signals received by the first portable audio storage device from the remote control are used by a voice user interface feature of the first portable audio storage device to control output of audio signals stored on the first portable audio storage device. Signals representing a second human voice are transmitted from the first portable audio storage device to the remote control when the first portable audio device is connected to the dock.

In still another aspect, a remote control for a sound output device includes a connector for electrically connecting the remote control to the sound output device. The remote control operates as a first type of wireless device when the remote control is connected to the sound output device, and operates as a second type of wireless device when the remote control is not connected to the sound output device.

Embodiments may include one or more of the following features. The first type of wireless device is a wireless receiver for receiving wireless audio signals. The second type of wireless device is a wireless communications headset which includes both a speaker and a microphone. A rechargeable battery in the remote control can be charged when the remote control is connected to the sound output device. A portable audio storage device which can provide audio signals to the sound output device for reproduction can be electrically connected to the sound output device by a connector of the sound output device when the remote control is not connected to the connector of the sound output device.

In still another aspect, an apparatus includes a housing and a first control surface, associated with the housing, for wirelessly controlling output of audio signals from a portable audio storage device connected to a sound output device. Also included are a microphone and speaker, associated with the housing, that are engaged when the apparatus is being used to participate in a wireless phone call.

An embodiment may include the following feature. A second control surface is included that is involved in one or more of initiating a wireless phone call and ending a wireless phone call.

### BRIEF DESCRIPTION OF THE DRAWINGS

FIG. 1 is a perspective view of a remote control;

FIG. 2 is a schematic block diagram of the functional aspects of the remote control of FIG. 1;

FIG. 3 is a front view of the remote control of FIG. 1, a portable audio storage device, and a sound output device;

FIG. 4 is a front view of the remote control of FIG. 1, the portable audio storage device and a sound output device of FIG. 3, and an additional portable audio storage device; and

FIG. 5 is a schematic diagram of another example of a sound output device.

### DETAILED DESCRIPTION

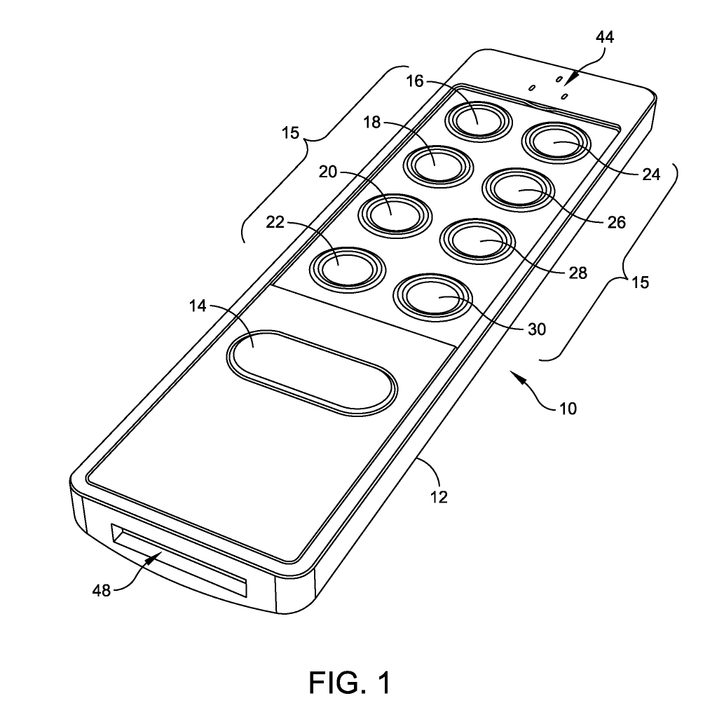

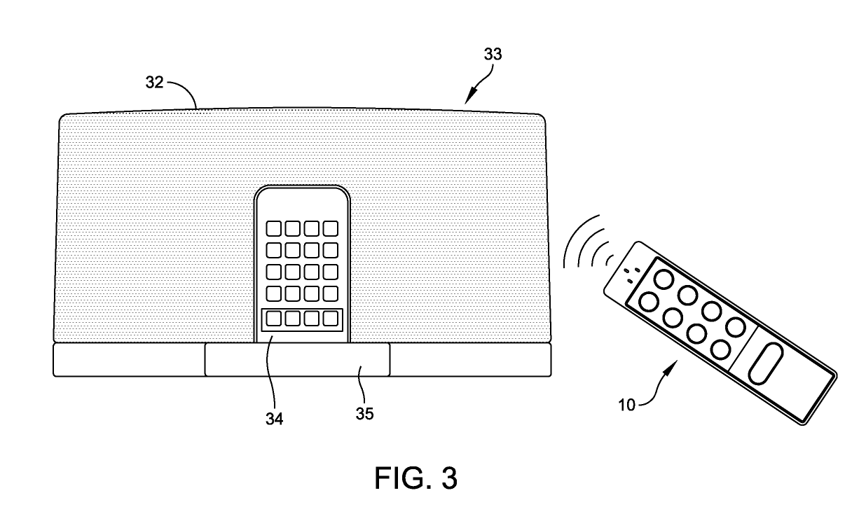

Referring to FIGS. 1 and 3, a remote control 10 includes a housing 12 and a voice command/phone button (control surface) 14. Operation of button 14 will be explained in further detail below. A group 15 of eight buttons (control surfaces) 16, 18, 20, 22, 24, 26, 28 and 30 control operation of (i) a sound output device 32 (in this example a SoundDock® II digital music system by Bose Corp.) of a sound system 33, and (ii) a first portable audio storage device 34 (in this example an iPhone device, iPhone is a trademark of Apple Inc., registered in the U.S. and other countries). The sound output device 32 includes one or more speakers (not shown) for producing sounds. A female thirty pin connector on the bottom of the device 34 electrically temporarily connects device 34 to the device 32 via a male thirty pin connector (not shown) in a dock 35. In this example the dock 35 is physically part of the sound output device 32. The device 34 also includes a wireless telephone system such as a cellular device such that the device 34 can be used to wirelessly make and receive telephone calls.

With reference to FIG. 1, the button 16 turns off both the sound output device 32 and audio storage device 34 when pressed if both devices are in an on state. Button 18 increases the volume of the sound output device 32 when pressed, and button 20 decreases the volume of the sound output device 32 when pressed. To return to the beginning of an audio track stored on device 34, button 22 is pressed once. To quickly scan backward through a track stored on device 34, press and hold button 22. To skip to the beginning of a previous track stored on device 34, press button 22 twice. To skip to a next track stored on device 34, press button 30 once. To quickly scan through a track stored on device 34, press and hold button 30. To skip forward to a next playlist stored on device 34, press button 26. To skip back to a previous playlist stored on device 34, press button 28. To pause audio being played by device 34, press button 24 once. To resume play, press button 24 again. When devices 32 and 34 are off, pressing any of buttons 18, 20, 22, 26, 28 or 30 will wake up devices 32 and 34 but will not cause audio to start playing. When devices 32 and 34 are off, pressing button 24 will wake up devices 32 and 34 and will cause audio to start playing. This paragraph describes one way in which the group of buttons 15 can be mapped to control functions on the devices 32 and 34. Other arrangements of buttons or control surfaces (e.g. touch sensitive surfaces) can be used to control the functions of the devices 32 and 34.

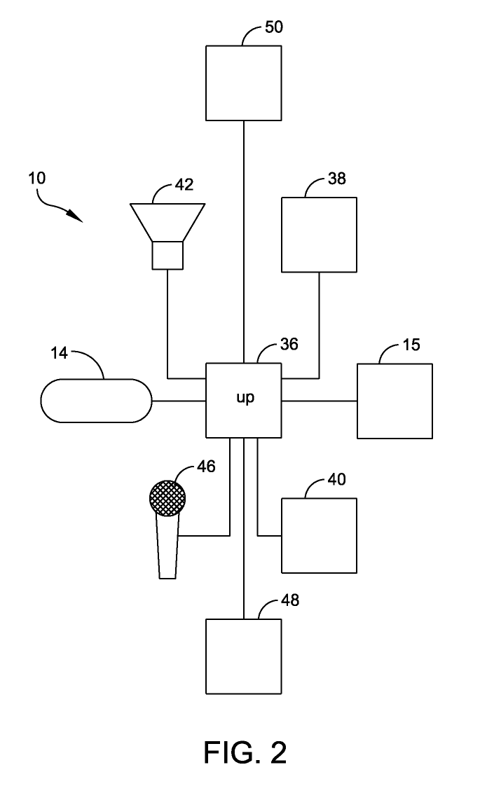

Referring to FIGS. 2-3, pressing any of the buttons in group 15 signals a microprocessor (up) 36 to cause a first type of wireless system 38 of the remote control to transmit a wireless command for controlling operation of devices 32 and/or 34. In this example, system 38 includes an infra red (IR) transmitter which operates in the IR band and sends commands to an IR receiver in the sound output device 32. A different type of wireless system besides IR can be used for system 38. If the command is for the device 32, then device 32 executes the command. If the command is for the device 34, then device 32 transmits the command through an electrical connection to the device 34 which executes the command. Alternatively, commands for device 34 can be received directly by device 34. If the command is for both devices 32 and 34, then both devices 32 and 34 execute the command. If two-way communication is desired between the device 32 and the remote control 10, the IR transmitter is replaced with an IR transceiver.

Turning to FIG. 2, remote control 10 includes a second type of wireless system 40, which in this example includes a Bluetooth two-way radio frequency (RF) communication system (preferably class 1 or 2). Bluetooth specification documents can be obtained by writing to Bluetooth SIG, Inc., 5209 Lake Washington Blvd. NE, Suite 350, Kirkland, Wash. 98033, or calling (425) 691-3535, or downloading the documents from this web address: http://www.bluetooth.com/English/Technology/Building/Pages/Specifcation.aspx. System 40 operates in the RF band and is used for wirelessly transmitting signals that represent sounds from a first human voice from the remote control 10 to the device 34 (FIG. 3). The remote control 10 also includes a speaker 42 (see FIG. 2) which creates sound waves that pass through openings 44 (FIG. 1) in the housing 12. The speaker 42 is used to reproduce the sound of a second human voice from a corresponding signal representing this voice which was wirelessly received by the remote control from the device 34 (the device 34 having wirelessly received signals representing the second human voice over a cellular phone system from a remote location). Further included in the remote control 10 is a microphone 46 and a female thirty pin connector 48. The microphone 46 receives sound waves from the environment external to the housing 12 through the 30 pin connector 48. Alternatively, openings (not shown) in the housing 12 similar to the openings 44 may be provided in the vicinity of the microphone 46 to allow sound waves outside the housing 12 to reach the microphone 46. The microphone is used to electronically capture the sounds created by a human voice and pass the resulting signals to system 40 for wireless transmission to the device 34. The remote control 10 also includes a battery or batteries 50 which are preferably rechargeable.

Referring to FIG. 3, when the remote control 10 and device 34 are first used together, the Bluetooth systems in the remote control and device 34 must be paired with each other. This generally happens automatically when the remote control 10 and device 34 both have their Bluetooth radios turned on and are located in the same room (for class 2 Bluetooth) or within the same house (for class 1 Bluetooth). If automatic pairing does not happen, the user will typically enter a four digit code (e.g. 0000 or 1234) into device 34. This code will be provided, for example, in the owner's guide for the remote control 10. After the initial pairing of the remote control 10 and the device 34, these two components should automatically connect with each other whenever they are brought into the vicinity of each other (e.g. same room or same house as described above). The remote control 10 is set as a Bluetooth headset which is a type of wireless device.

With reference to FIGS. 1-3, when the portable audio storage device 34 is connected to the sound output device 32 as described above, the group of buttons 15 can be used to control playback of audio signals stored on device 34 by device 32 (see above). In addition, the button 14 can be used to activate a voice user interface (UI) system in the device 34. The button 14 may be a multifunction button, where the operation controlled by a press of the button 14 depends on the state of the device 34. For example, when the device 34 is not currently processing a cellular call, pressing the button 14 may initiate a voice UI on the device 34. Subsequent spoken commands into the remote control 10 are then used to control the device 34. Any voice UI function available on the device 34 may be controlled by voice commands issued by the remote control 10 provided the device 34 exposes its voice API. Alternatively, the sound output device 32 could reproduce voice signals received from the device 34 which originated at the remote control 10. As such the voice UI functions of the device 34 are accessed as if the user were directly speaking into the device 34.

When the button 14 is pressed, a wireless signal is sent to the device 34 indicating that a voice-UI command should be received soon. The user then states a command at the remote control 10 such as “fast forward” or “next track”. This vocal command is picked up by the microphone 46 in the remote control 10. Signals from the microphone 46 that represent the sounds of the human voice of the user are wirelessly transmitted by the wireless system 40 to the device 34. The device 34 recognizes and executes the command. As such, signals (representing a human voice) received by the device 34 from the remote control 10 are used by the voice UI feature of the device 34 to control output of audio signals stored on the device 34.

A user can also initiate a cellular phone call by pressing button 14 and then stating, for example, “call Kim” at the remote control 10. As already described, this command is transmitted to the device 34 which executes the command by dialing the phone number for Kim which had been previously stored in the device 34. If the phone call is answered, the user speaks into the microphone 46 to talk to Kim and listens to sounds from the speaker 42 to hear Kim's voice. As such, signals representing two human voices are transmitted between the remote control 10 and the device 34 over the wireless system 40. The device 34 transmits/receives signals representing these two voices to/from the cellular system.

In another example, the button 14 may be used to initiate a call answer function when a cellular call is received by the device 34. In this case, the device 34 and/or the device 32 will sound a ring tone to alert the user to an incoming call. Because the remote control 10 uses standard Bluetooth headset protocols, a press of the button 14 will answer the call. When the device 34 is receiving a new inbound phone call, it knows that a signal received as a result of the button 14 being pressed is indicating that the call should be answered. When the device 34 is not involved in a cellular phone call, the device 34 knows that a signal received as a result of the button 14 being pressed is indicating that a voice UI command should be arriving shortly. In summary, when the device 34 receives a phone call, this call can be answered by pressing the button 14. The call then proceeds as described above. A benefit of this arrangement is that the user does not need to walk over to the sound system 33 in order to make and receive phone calls. The user merely picks up the remote control 10 in order to place and receive phone calls.

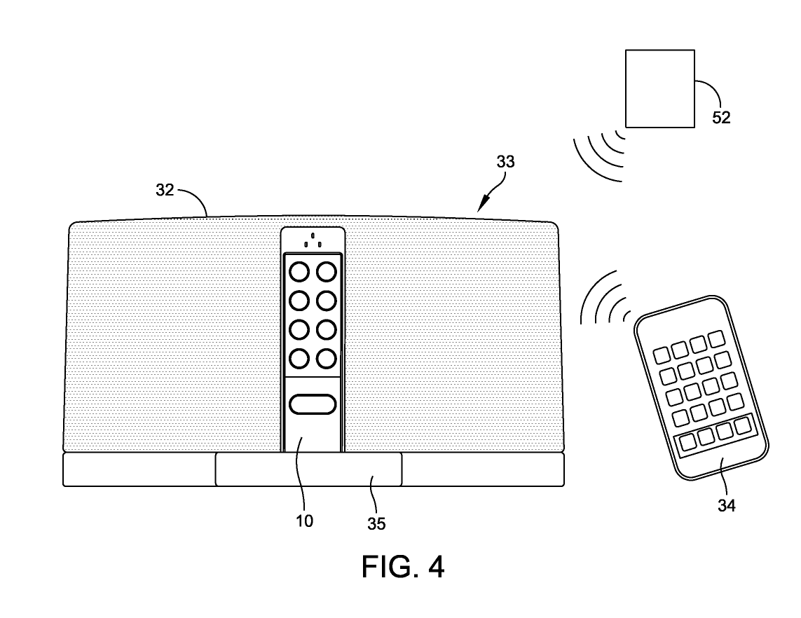

Turning to FIG. 4, when the device 34 is removed from the dock 35 such that the device 34 is not electrically connected to the sound output device 32, the remote control 10 can be electrically temporarily connected to the dock 35 of the sound output device 32 at the same location where the device 34 was connected to the sound output device. In other words, the female thirty pin connector 48 on one end of the remote is inserted onto the male thirty pin connector in the dock 35. As such, the remote control 10 and the device 34 can each connect to the same electrical connector on the sound output device 32. When this connection is made, the remote control 10 resets itself to act as an audio signal receiver (a type of wireless device) which preferably can receive stereo audio (e.g. A2DP) signals.

As such, when the device 34 transmits (stereo) audio signals over its Bluetooth wireless system, these signals are received by the wireless system 40 of the remote control 10. These audio signals are electrically transmitted by the remote control to a speaker of the sound output device 32 for creating sound. Any Bluetooth source can connect and pass audio to the remote control 10. A second portable audio storage device 52 with a Bluetooth wireless system can alternatively transmit wireless audio signals to the remote control 10. These signals are received by the wireless system 40 of the remote control 10 and used to produce sound as described earlier in this paragraph. The device 52 is different from the device 34. Any audio storage device that includes a Bluetooth wireless system can be used to transmit audio signals to the wireless system 40 of the remote control 10. When the remote control 10 is connected to the dock 35, the rechargeable battery 50 in the remote control is electrically charged. The remote control 10 uses the same wireless system 40 for receiving audio signals (when connected to the dock 35) as is used to transmit the human voice signals to the first portable audio storage device 34 (when the device 34 is connected to the dock 35).

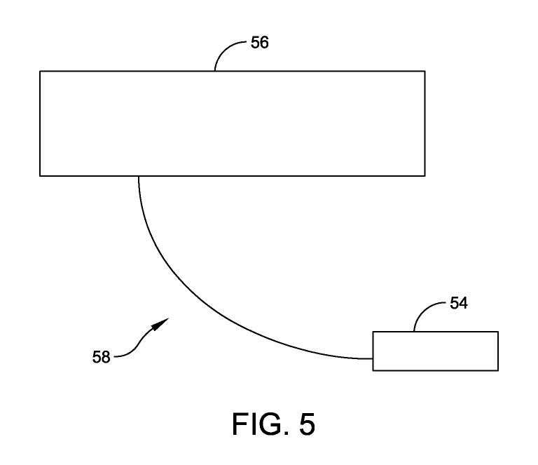

With reference to FIG. 5, another example is shown in which a dock 54 is physically separate from a sound output device 56. An insulated electrical wire 58 electrically connects the dock 58 and the sound output device 56. The wire can pass electrical communication signals between the dock 54 and the device 56. Power cords (not shown) provide electrical power to each of the dock 54 and device 56. Other than the dock 54 being physically separate from the device 56, this example functions essentially the same as was described above for FIGS. 1-4. The remote control 10 or device 34 are connected to a male thirty pin connector in the dock 54 and operate as described above. The Wave® music system with connect kit for iPod® available from Bose Corporation is representative of this example.

A number of implementations have been described. Nevertheless, it will be understood that additional modifications may be made without departing from the spirit and scope of the inventive concepts described herein, and, accordingly, other embodiments are within the scope of the following claims.

What is claimed is:

1. A, remote control for a sound system, comprising:
a first type of wireless system for transmitting commands for controlling operation of a sound output device; and
a second type of wireless system for wirelessly transmitting signals that represent sounds created by a first human voice to a first portable audio storage device which can be electrically temporarily connected to the sound output device.

2. The remote control of claim 1, wherein the first type of wireless system operates in the infrared band.

3. The remote control of claim 1, wherein the second type of wireless system operates in the radio frequency band.

4. The remote control of claim 1, wherein the first portable audio storage device includes a voice user interface feature that reacts to the signals by controlling output of audio signals stored on the first portable audio storage device for reproduction by the sound output device.

5. The remote control of claim 1, further including a rechargeable battery that can be recharged when the remote control is connected to the sound output device.

6. The remote control of claim 1, wherein the remote control further includes a microphone for capturing the first human voice and a speaker for reproducing a second human voice which has been wirelessly received by the remote control from the first portable audio storage device, the first portable audio storage device having wirelessly received the second human voice from a remote location.

7. The remote control of claim 1, wherein when the first portable audio storage device is not electrically connected to the sound output device, the remote control can be electrically temporarily connected to the sound output device at a same location as where the first portable audio storage device connects to the sound output device.

8. The remote control of claim 1, wherein the second wireless system wirelessly receives audio signals from the first portable audio storage device.

9. The remote control of claim 1, wherein the second wireless system wirelessly receives audio signals from a second portable audio storage device that is different from the first portable audio storage device.

10. A sound system, comprising:
a sound output device including a speaker for producing sounds;
a remote control for transmitting wireless commands over a first wireless system for controlling operation of the sound output device; and
a dock to which the remote control and a first portable audio storage device can be interchangeably electrically connected.

11. The sound system of claim 10, wherein the remote control includes a second wireless system capable of receiving wireless audio signals and providing said wireless audio signals to the sound system when the remote control is electrically connected to the sound system.

12. The sound system of claim 11, wherein the wireless audio signals are received by the remote control from the first portable audio storage device.

13. The sound system of claim 11, wherein the wireless audio signals are received by the remote control from a second portable audio storage device which is different from the first portable audio storage device.

14. The sound system of claim 11, wherein when the remote control is electrically connected to the dock, a rechargeable battery in the remote control is electrically charged.

15. The sound system of claim 14, wherein when the portable audio storage device is connected to the dock, the remote control can wirelessly transmit signals representing sounds created by a first human voice to the portable audio storage device.

16. The sound system of claim 15, wherein the portable multimedia storage device can wirelessly transmit audio signals representing sounds created by a second human voice to the remote control.

17. A method of operating a sound system, comprising the steps of:
providing a sound output device that includes a dock;
temporarily electrically connecting one of a remote control device and a first portable audio storage device to the dock;
wirelessly receiving audio signals at the remote control when the remote control is connected to the dock, and
wirelessly transmitting signals representing a first human voice from the remote control to the first portable audio device when the first portable audio device is connected to the dock.

18. The method of claim 17, wherein the remote control uses a same wireless system for receiving audio signals as is used to transmit the human voice signals to the first portable audio storage device.

19. The method of claim 17, wherein when the remote control is connected to the dock, the audio signals are used by the sound output device to create sound.

20. The method of claim 17, wherein when the first portable audio storage device is connected to the dock, the human voice signals received by the first portable audio storage device from the remote control are used by a voice user interface feature of the first portable audio storage device to control output of audio signals stored on the first portable audio storage device.

21. The method of claim 17, wherein signals representing a second human voice are transmitted from the first portable audio storage device to the remote control when the first portable audio device is connected to the dock.

22. A, remote control for a sound output device, comprising:
a connector for electrically connecting the remote control to the sound output device, wherein the remote control operates as a first type of wireless device when the remote control is connected to the sound output device, and the remote control operates as a second type of wireless device when the remote control is not connected to the sound output device.

23. The remote control of claim 22, wherein the first type of wireless device is a wireless receiver for receiving wireless audio signals.

24. The remote control of claim 22, wherein the second type of wireless device is a wireless communications headset which includes both a speaker and a microphone.

25. The remote control of claim 22, wherein a rechargeable battery in the remote control can be charged when the remote control is connected to the sound output device.

26. The remote control of claim 22, wherein a portable audio storage device which can provide audio signals to the sound output device for reproduction can be electrically connected to the sound output device by a connector of the sound output device when the remote control is not connected to the connector of the sound output device.

27. An apparatus, comprising:
a housing;
a first control surface, associated with the housing, for wirelessly controlling output of audio signals from a portable audio storage device connected to a sound output device; and
a microphone and speaker, associated with the housing, that are engaged when the apparatus is being used to participate in a wireless phone call.

28. The apparatus of claim 27, further including a second control surface that is involved in one or more of initiating a wireless phone call and ending a wireless phone call.
